(19) United States
(12) Patent Application Publication
(10) Pub. No.: US 2015/0245613 A1
(43) Pub. Date: Sep. 3, 2015

(54) PLANT DISEASE CONTROLLING AGENT, PLANT DISEASE CONTROLLING METHOD, AND PLANT DISEASE CONTROLLING PRODUCT

(71) Applicant: Kureha Corporation, Tokyo (JP)

(72) Inventors: Hideaki Tateishi, Tokyo (JP); Thomas Grote, Wachenheim (DE); Jochen Dietz, Karlsruhe (DE); Jurith Montag, Mannheim (DE); Egon Haden, Speyer (DE)

(73) Assignee: Kureha Corporation, Tokyo (JP)

(21) Appl. No.: 14/417,892

(22) PCT Filed: Sep. 12, 2013
(86) PCT No.: PCT/JP2013/005423

§ 371 Date: Jan. 28, 2015

(30) Foreign Application Priority Data
Oct. 15, 2012 (JP) 2012-228346

(51) Int. Cl. A01N 43/653; A01N 43/56

(52) U.S. Cl. CPC A01N 43/653; A01N 43/56

(57) ABSTRACT

The present invention provides a plant disease controlling agent, which is low in active ingredient content. A plant disease controlling agent of the present invention contains, as active ingredients, (i) a triazole compound represented by general formula (I) and (ii) fluxapyroxad, wherein X represents a chlorine atom or a fluorine atom.

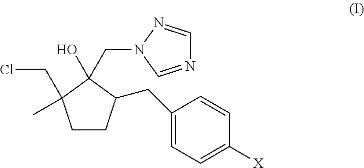

### TECHNICAL FIELD

The present invention relates to a plant disease controlling agent, a plant disease controlling method, and a plant disease controlling product. In more detail, the present invention relates to a plant disease control composition which contains two kinds of active ingredients, a plant disease controlling method which employs the plant disease control composition, and plant disease controlling products which contain the respective two kinds of active ingredients.

### BACKGROUND ART

Patent Literature 1 describes a 2-(halogenated hydrocarbon-substituted)-5-benzyl-1-azolylmethylcyclopentanol derivative as a compound that can be employed as an active ingredient of an agent such as an agro-horticultural agent or an industrial material protecting agent.

Patent Literature 2 describes a pyrazole carboxylic acid anilide derivative which can be used to control destructive microorganisms.

### CITATION LIST

### Patent Literature

PTL 1: International Publication, No. WO2011/070771 (Publication Date: Jun. 16, 2011)

PTL 2: Japanese Translation of PCT International Application, Tokuhyo No. 2008-530059 A (Publication Date: Aug. 7, 2008)

### SUMMARY OF INVENTION

### Technical Problem

Disease control carried out by use of a plant disease controlling agent has problems such as (i) influence on non-target organisms, (ii) influence on the environment and (iii) emergence of fungicide-resistant pathogens. Therefore, there has a strong demand for chemicals which can show a great controlling effect with a reduced spray amount of the chemicals in order to lower toxicity to the non-target organisms, reduce negative effects on the environment, and reduce the emergence of fungicide-resistant pathogens.

The present invention was made in view of the problems, and a main object of the present invention is to provide a plant disease controlling agent which shows an effect equivalent to those of conventional chemicals even though a spray amount of the plant disease controlling agent is smaller than those of the conventional chemicals.

### Solution to Problem

In order to attain the object, a plant disease controlling agent of the present invention is configured to contain, as active ingredients, (i) fluxapyroxad and (ii) a triazole compound which is represented by general formula (I),

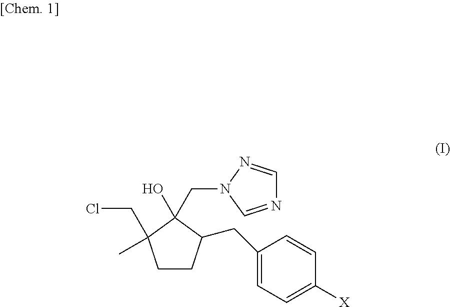

where X represents a chlorine atom or a fluorine atom.

In order to attain the object, a plant disease controlling method of the present invention is arranged to include the step of carrying out a foliage treatment or a non-foliage treatment by use of the plant disease controlling agent.

In order to attain the object, a plant disease controlling product of the present invention is configured to separately contain fluxapyroxad, and a triazole compound which is represented by general formula (I),

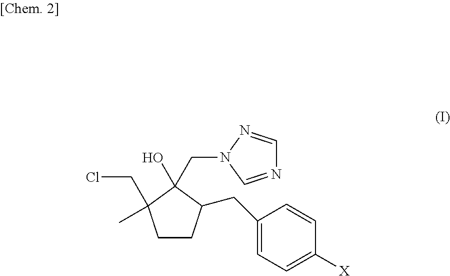

where X represents a chlorine atom or a fluorine atom,

the fluxapyroxad and the triazole compound being active ingredients to be mixed with each other before use.

### Advantageous Effects of Invention

A plant disease controlling agent of the present invention contains two kinds of compounds, thereby showing a great synergetic controlling effect.

### DESCRIPTION OF EMBODIMENTS

The following description will discuss an embodiment of the present invention.

(Active Ingredient)

A plant disease controlling agent of the present invention is a so-called admixture, and contains, as active ingredients, fluxapyroxad, and a triazole compound which is represented by the following general formula (I) (hereinafter, referred to as a triazole compound (I)),

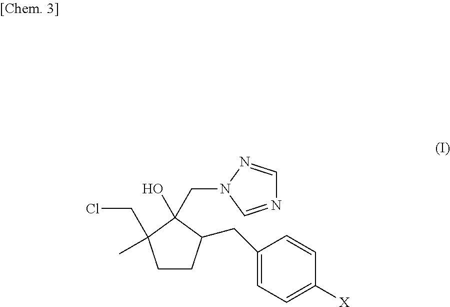

where X represents a chlorine atom or a fluorine atom.

The triazole compound (I) forms (i) an acid addition salt to which an inorganic acid or an organic acid is added or (ii) a metal complex, because the triazole compound (I) has a 1,2,4-triazole group. The acid addition salt or the metal complex thus formed can be employed as the triazole compound (I).

The triazole compound (I) contains three asymmetric carbons. Therefore, the triazole compound (I) has various stereoisomers (enantiomers or diastereomers), and consists of a stereoisomer mixture or a single stereoisomer depending on its composition. It is therefore possible to employ at least one of the stereoisomers as an active ingredient of the plant disease controlling agent.

The triazole compound (I) can be produced by a conventionally well-known method, such as a method disclosed in Patent Literature 1.

Fluxapyroxad is a common name of 3-(difluoromethyl)-1-methyl-N-(3′,4′,5′-trifluorobiphenyl-2-yl)pyrazole-4-carboxamido, and is a compound represented by the following general formula (II).

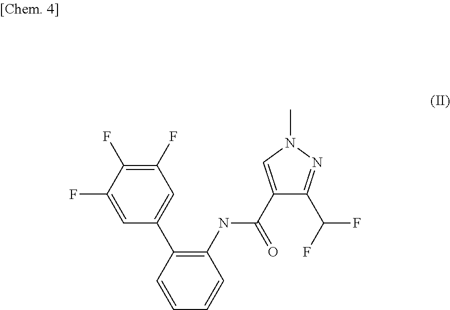

Fluxapyroxad can be produced by a conventionally well-known method, such as a method disclosed in Patent Literature 2.

The triazole compound (I) and fluxapyroxad each show an effect of controlling plant diseases of various agricultural crops. A plant disease controlling agent, which contains the triazole compound (I) and fluxapyroxad, shows a synergistic effect, as compared with a plant disease controlling agent which merely contains the triazole compound (I) or fluxapyroxad.

To show the synergistic effect, a mixture ratio of the triazole compound (I) to fluxapyroxad can be in a wide range. For example, the mixture ratio by weight can fall within a range from 1000:1 to 1:1000, and preferably from 100:1 to 1:100. Particularly, the mixture ratio more preferably falls within a range from 20:1 to 1:80, and most preferably from 2:1 to 1:8.

(Plant Disease Controlling Agent)

The plant disease controlling agent can contain other formulation auxiliary agent such as a solid carrier, a suspension carrier (diluent) or a surfactant, in addition to the triazole compound (I) and fluxapyroxad. Therefore, the plant disease controlling agent can be in various dosage forms such as dust formulation, wettable powder, granules or an emulsifiable concentrate.

The total quantity of the triazole compound (I) and fluxapyroxad in the plant disease controlling agent preferably accounts for 0.1% to 95% by weight, more preferably 0.5% to 90% by weight, and most preferably 2% to 80% by weight of the plant disease controlling agent.

Examples of the solid carrier to be employed as a formulation auxiliary agent include talc, caolin, bentonite, diatomite, white carbon, and clay. Examples of the suspension carrier to be employed as a formulation auxiliary agent include water, xylene, toluene, chlorobenzene, cyclohexane, cyclohexanone, dimethyl sulfoxide, dimethylformamide, and alcohol. The surfactant can be employed depending on its effect. In a case where the plant disease controlling agent is an emulsifiable concentrate, for example, polyoxyethylene alkyl aryl ether or polyoxyethylene sorbitan monolaurate can be employed as the surfactant. In a case where the plant disease controlling agent is a dispersant, for example, lignin sulfonate or dibutyl naphthalene sulfonate can be employed as the surfactant. In a case where the plant disease controlling agent is a wetting agent, for example, alkyl sulfonate or alkyl phenyl sulfonate can be employed as the surfactant.

The plant disease controlling agent can be used as it is. Alternatively, the plant disease controlling agent can be used after being diluted with a diluent such as water to have a predetermined concentration. Note that in a case where the plant disease controlling agent thus diluted is used, it preferably contains active ingredients whose total concentration falls within a range from 0.001% to 1.0% with respect to the total amount of the plant disease controlling agent thus diluted.

Since the plant disease controlling agent shows a synergistically controlling effect, it is possible to reduce an amount of an active ingredient compound to be used so as to show an effect equivalent to that showed by a plant disease controlling agent that merely contains the triazole compound (I) or fluxapyroxad. This makes it possible to lower toxicity to non-target organisms and to reduce negative effects on the environment. It is also possible to reduce amounts of the triazole compound (I) and fluxapyroxad to be used. It is therefore expected to reduce emergence of fungicide-resistant pathogens. Further, the plant disease controlling agent of the present embodiment contains, as active ingredients which show an effect of controlling plant diseases, the two active ingredients which are remarkably different in molecular structure from each other. This allows the plant disease controlling agent to control a wide variety of diseases.

The plant disease controlling agent can be prepared by mixing agents having been prepared separately to respectively contain the active ingredients. Therefore, the present invention encompasses a plant disease controlling product that includes the triazole compound (I) and fluxapyroxad in the form of separate preparations to be mixed with each other before use in controlling plant diseases.

(Plant Disease Controlling Effect)

The plant disease controlling agent of the present invention shows an effect of controlling a wide variety of plant diseases. The following describes exemplary diseases to be controlled by the plant disease controlling agent of the present invention.

The plant disease controlling agent controls wheat diseases such as wheat powdery mildew (Erysiphe graminis f. sp tritici), wheat brown rust (Puccinia recondita), wheat stripe rust (Puccinia striiformis), wheat eye spot (Pseudocercosporella herpotrichoides), wheat Fusarium head blight (Fusarium graminearum, Microdochium nivale), wheat glume blotch (Phaeosphaeria nodorum), wheat leaf blight (Septoria tritici), wheat pink snow mold (Microdochium nivale), wheat take-all (Gaeumannomyces graminis), wheat clume spot (Epicoccum spp), and wheat yellow spot (Pyrenophora tritici-repentis).

The plant disease controlling agent also controls plant diseases such as soybean rust (Phakopsora pachyrhizi, Phakopsora meibomiae), rice blast (Pyricularia grisea), rice brown spot (Cochliobolus miyabeanus), rice leaf blight (Xanthomonas oryzae), rice sheath blight (Rhizoctonia solani), rice stem rot (Helminthosporium sigmoideun), rice Bakanae disease (Gibberella fujikuroi), rice bacterial seeding blight (Pythium aphanidermatum), apple powdery mildew (Podosphaera leucotricha), apple scab (Venturia inaequalis), apple blossom blight (Monilinia mali), apple alternaria blotch (Alternaria alternata), apple valsa canker (Valsa mali), pear black spot (Alternaria kikuchiana), pear powdery mildew (Phyllactinia pyri), pear rust (Gymnosporangium asiaticum), pear scab (Venturia nashicola), grape powdery mildew (Uncinula necator), grape downy mildew (Plasmopara viticola), grape ripe rot (Glomerella cingulata), barley powdery mildew (Erysiphe graminis f. sp hordei), barley stem rust (Puccinia graminis), barley stripe rust (Puccinia striiformis), barley stripe (Pyrenophora graminea), barley leaf blotch (Rhynchosporium secalis), gourd powdery mildew (Sphaerotheca fuliginea), gourd anthracnose (Colletotrichum lagenarium), cucumber downy mildew (Pseudoperonospora cubensis), cucumber phytophthora rot (Phytophthora capsici), tomato powdery mildew (Erysiphe cichoracearum), tomato early blight (Alternaria solani), eggplant powdery mildew (Erysiphe cichoracearum), strawberry powdery mildew (Sphaerotheca humuli), tobacco powdery mildew (Erysiphe cichoracearum), sugar beet cercpspora leaf spot (Cercospora beticola), maize smut (Ustilago maydis), plum brown rot (Monilinia fructicola), various plants-affecting gray mold (Botrytis cinerea), sclerotinia rot (Sclerotinia sclerotiorum), barley loose smut (Ustilago nuda), grape rust (Phakopsora ampelopsidis), tabacco brown spot (Alternaria longipes), potato early blight (Alternaria solani), soybean brown spot (Septoria glycines), soybean purple stain (Cercospora kikuchii), watermelon wilt (Fusarium oxysporum f.sp. niveum), cucumber wilt (Fusarim oxysporum f. sp. cucumerinum), citrus blue mold (Penicillium italicum), white radish yellow (Fusarium oxysporum f. sp. raphani), maize anthracnose (Colletotrichum graminicola), maize eye pot (Kabatiella zeae), maize gray leaf spot (Cercospora zeae-maydis), maize northern leaf blight (Setosphaeria turcica), maize northern leaf blight (Cochliobolus carbonum), maize leaf spot (Physoderma maydis), maize rust (Puccinia spp), maize brown spot (Bipolaris maydis), maize yellow spot (Phyllosticta maydis), maize Fusarium head blight (Gibberella zeae), barley net blotch (Pyrenophora teres), barley Fusarium head blight (Fusarium graminearum, Microdochium nivale), and sugarcane rust (Puccinia spp).

The plant disease controlling agent of the present invention shows a remarkably excellent effect in controlling wheat diseases among these diseases. Therefore, the plant disease controlling agent is suitably used to control wheat diseases. The plant disease controlling agent, however, is not limited to such application.

Examples of applicable plants include (i) wild plants, (ii) cultivated plant caltivars, (iii) plants and cultivated plant caltivars, which are obtained by conventional biological breeding such as crossbreeding or protoplast fusion and (iv) genetically modified plants and genetically-modified cultivated plant caltivars, which are obtained by genetic engineering. Examples of the genetically modified plants and the genetically-modified cultivated plant caltivars include (i) herbicide resistant crops, (ii) insect pest resistant crops into which insecticidal protein producing genes are integrated, (iii) disease resistant crops into which disease-resistant inducer producing genes are integrated, (iv) palatably improved crops, (v) productively improved crops, and (vi) preservably improved crops. More specific examples of the genetically-modified cultivated plant caltivars include ROUNDUP READY, LIBERTYLINK, CLEARFIELD, YIELDGARD, HERCULEX, and BOLLGARD, all of which are registered trademarks.

(Plant Disease Controlling Method)

The plant disease controlling agent of the present invention can be used not only in a foliage treatment such as foliage application but also in a non-foliage treatment such as a seed treatment, a soil-drenching treatment or a water surface treatment. Therefore, a plant disease controlling method of the present invention includes the step of carrying out the foliage treatment or the non-foliage treatment by use of the plant disease controlling agent. Note that the non-foliage treatment can save more labor than the foliage treatment.

In the seed treatment, the plant disease controlling agent is adhered to seeds by, for example, (i) mixing dust formulation or wettable powder of the plant disease controlling agent with the seeds, and then stirring them or (ii) immersing the seeds in a suspension of wettable powder of the plant disease controlling agent. The total amount of the active ingredients to be used with respect to 100 kg of seeds in the seed treatment falls within, for example, a range from 0.01 g to 10000 g, and preferably a range from 0.1 g to 1000 g. The seeds to which the plant disease controlling agent has been adhered can be used in the same manner as normal seeds.

In the soil-drenching treatment, for example, (i) granules of the plant disease controlling agent are (i) put in holes into which seedlings are to be transplanted or (ii) sprayed around the holes. Alternatively, for example, granules and wettable powder of the plant disease controlling agent are provided to soil surrounding seeds or plants. The total amount of the active ingredients to be used for each square meter of agro-horticultural land in the soil-drenching treatment falls within, for example, a range from 0.01 g to 10000 g, and preferably a range from 0.1 g to 1000 g.

In the water surface treatment, for example, granules of the plant disease controlling agent are provided to water of paddy fields. The total amount of the active ingredients to be used per ten acres of paddy fields in the water surface treatment falls within, for example, a range from 0.1 g to 10000 g, and preferably a range from 1 g to 1000 g.

The total amount of the active ingredients to be used for each hectare of agro-horticultural land, such as a field, a paddy field, an orchard, or a greenhouse, in foliage application falls within, for example, a range from 20 g to 5000 g, and preferably a range from 50 g to 2000 g.

Note that the amount and concentration of the active ingredients to be used vary depending on conditions such as (i) dosage form of the active ingredients, (ii) when they are used, (iii) how they are used, (iv) where they are used and (v) target crops for which they are used. Therefore, the amount of the active ingredients to be used is not limited to the above-described amount, but can be increased or decreased beyond the above ranges.

### SUMMARY

The plant disease controlling agent of the present invention contains, as active ingredients, (i) fluxapyroxad and (ii) a triazole compound which is represented by the aforementioned general formula (I).

It is preferable to arrange the plant disease controlling agent of the present invention such that a mixture ratio by weight of the triazole compound to the fluxapyroxad falls within a range from 20:1 to 1:80.

It is preferable to arrange the plant disease controlling agent of the present invention such that a mixture ratio by weight of the triazole compound to the fluxapyroxad falls within a range from 2:1 to 1:8.

It is preferable that the plant disease controlling agent of the present invention is for use in controlling wheat diseases.

The plant disease controlling method of the present invention includes the step of carrying out a foliage treatment or a non-foliage treatment by use of the aforementioned plant disease controlling agent.

A plant disease controlling product of the present invention separately contains fluxapyroxad, and a triazole compound which is represented by the aforementioned general formula (I), the fluxapyroxad and the triazole compound being active ingredients to be mixed with each other before use.

The following examples will describe the embodiment of the present invention in further detail. It goes without saying that the present invention is not limited to the examples, and the examples can therefore be modified in detailed parts. Moreover, the present invention is not limited to the description of the embodiment above, and can therefore be modified by a skilled person in the art within the scope of the claims. Namely, an embodiment derived from a proper combination of technical means disclosed in different embodiments is encompassed in the technical scope of the present invention. All documents described in the specification are used as references.

### EXAMPLES

### Production Example 1: synthesis of (1RS,2SR,5SR)-5-(4-chlorobenzyl)-2-chloromethyl-2-methyl-1-(1H-1,2,4-triazole-1-yl methyl)cyclopentanol (compound I-1)

Under argon atmosphere, (1RS,2RS,3SR)-p-toluenesulfonic acid 3-(4-chlorobenzyl)-2-hydroxy-1-methyl-2-(1H-1,2,4-triazole-1-ylmethyl)cyclopentylmethylester (0.0245 mmol) was dissolved in dehydrated DMF (dimethylformamide) (0.24 ml). Subsequently, lithium chloride (0.245 mmol) was added to the resultant dissolved, and then the resultant mixture was stirred at 100 degrees C. for one and half hours. Subsequently, ethyl acetate (2 ml) was added to the reaction suspension, and then the reaction suspension was washed with saturated brine. An organic layer thus obtained was dried with anhydrous sodium sulfate, and then concentrated. The resultant concentrated was purified by means of silica gel column chromatography, so that the following compound I-1 was obtained.

Yield: 58%

¹H-NMR (400 MHz, CDCl₃) delta: 1.18 (3H, s), 1.46 (2H, m), 1.70 (1H, m), 1.92 (2H, m), 2.35 (2H, m), 3.26 (1H, d, J=10.8 Hz), 3.57 (1H, d, J=10.8 Hz), 4.06 (1H, s), 4.25 (1H, d, J=14.2 Hz), 4.54 (1H, d, J=14.2 Hz), 6.98 (2H, d, J=8.4 Hz), 7.21 (2H, d, J=8.4 Hz), 8.02 (1H, s), and 8.19 (1H, s)

### Production Example 2: synthesis of (1RS,2SR,5SR)-2-chloromethyl-5-(4-fluorobenzyl)-2-methyl-1-(1H-1,2,4-triazole-1-yl methy)cyclopentanol (compound I-2)

The following compound 1-2 was obtained by carrying out the same process as in Production Example 1, except that (1RS,2RS,3SR)-p-toluenesulfonic acid 3-(4-fluorobenzyl)-2-hydroxy-1-methyl-2-(1H-1,2,4-triazole-1-ylmethyl)cyclopentylmethylester, which was obtained by use of a method described in Patent Literature 1 and a conventionally well-known method, was used instead.

Yield: 99.6%

¹H-NMR (CDCl₃) delta: 1.18 (3H, s), 1.41-1.53 (2H, m), 1.65-1.76 (1H, m), 1.89-1.98 (2H, m), 2.28-2.38 (2H, m), 3.26 (1H, d, J=10.8 Hz), 3.57 (1H, d, J=10.8 Hz), 4.05 (1H, s), 4.25 (1H, d, J=14.2 Hz), 4.54 (1H, d, J=14.2 Hz), 6.92 (2H, t, J=8.7 Hz), 7.00 (2H, dd, J=8.7, 5.5 Hz), 8.01 (1H, s), or 8.19 (1H, s)

### Mixture Preparation Example 1 (Wettable Powder)

In this example, 25 parts of the compound I-1, 25 parts of fluxapyroxad, 5 parts of lignin sulfonate, 3 parts of alkyl sulfonic acid, and 42 parts of diatomite were ground and mixed to form wettable powder. The wettable powder, which was dispersed in water, was used.

### Mixture Preparation Example 2 (Dust Formulation)

In this example, 3 parts of the compound I-1, 3 parts of fluxapyroxad, 40 parts of clay, and 54 parts of talc were ground and mixed to form dust formulation. The dust formulation was used.

### Mixture Preparation Example 3 (Granules)

In this example, 2.5 parts of the compound I-1, 2.5 parts of fluxapyroxad, 43 parts of bentonite, 45 parts of clay, and 7 parts of lignin sulfonate were uniformly mixed, kneaded with water, made into granules by use of an extruding granulator, and then dried to form granules.

### Mixture Preparation Example 4 (Emulsifiable Concentrate)

In this example, 5 parts of the compound I-1, 5 parts of fluxapyroxad, 10 parts of polyoxyethylene alkyl aryl ether, 3 parts of polyoxyethylene sorbitan monolaurate, and 77 parts of xylene were uniformly mixed and dissolved to form an emulsifiable concentrate.

### Test Example 1

### Test for Examining Controlling Effect of Compound I-1 and Fluxapyroxad on Wheat Fusarium Head Blight

The compound I-1, and fluxapyroxad that was synthesized by use of a method described in Patent Literature 2 and a conventionally well-known method, were mixed at a predetermined ratio. A synergetic effect of the mixture on wheat Fusarium head blight was examined. Cut ears, cut from wheat plants (cultivar: NORIN No. 61) in flowering stage, were prepared. A chemical suspension, which contained the compound I-1 and fluxapyroxad, was prepared, and then a predetermined amount of the chemical suspension was sprayed over the cut ears. The cut ears were then left at room temperature for about one hour to be dried. Subsequently, a suspension containing ascospores of Fusarium graminearum (1×10⁵/ml) was sprayed over the cut ears, and then the cut ears were kept in a chamber at 20 degrees C. Five days after the inoculation, disease severity of wheat Fusarium head blight was evaluated by use of a method described in a document (see Ban & Suenaga Euphyitica 113, pages 87-99, (2000)). Each test was conducted in three test plots, each of which test plots included three ears. A theoretical preventive value (an expected preventive value) obtained in a case where the chemical suspension is sprayed was calculated, by use of the following Colby's formula, on the basis of (i) a preventive value obtained in a case where the compound I-1 is sprayed and (ii) a preventive value obtained in a case where fluxapyroxad is sprayed. In a case where an actual preventive value obtained in a case where the chemical suspension was actually sprayed is larger than the theoretical preventive value, it was determined that the chemical suspension showed a synergistic effect. In a case where the actual preventive value was equal to the theoretical preventive value, it was determined that the chemical suspension showed an additional effect. In a case where the actual preventive value was smaller than the theoretical preventive value, it was determined that the chemical suspension showed an antagonistic effect.

A (theoretical) preventive value obtained in a case where the chemical suspension is sprayed=A1+((100−A1)×A2)/100

where A1 and A2 represent (i) the preventive value obtained in a case where the compound I-1 is sprayed and (ii) the preventive value obtained in a case where fluxapyroxad is sprayed.

Table 1 shows the result of the test. As is clear from Table 1, the actual preventive value is larger than the theoretical preventive value. The compound I-1 and fluxapyroxad showed a synergistic effect.

TABLE 1

| | | | Theoretical preventive value |
|---|---|---|---|
| | | Actual | in case where mixture of |
| Compound | Fluxapyroxad | preventive | Compound I-1 and |
| I-1 (g/ha) | (g/ha) | value | Fluxapyroxad is sprayed |
| 0 | 0 | 0 | |
| 5 | 0 | 13 | |
| 10 | 0 | 39 | |
| 20 | 0 | 61 | |
| 0 | 10 | 3 | |
| 5 | 10 | 44 | 16 |
| 10 | 10 | 44 | 41 |
| 20 | 10 | 74 | 62 |
| 0 | 20 | 0 | |
| 5 | 20 | 26 | 13 |
| 10 | 20 | 58 | 39 |
| 20 | 20 | 88 | 61 |
| 0 | 40 | 4 | |
| 5 | 40 | 42 | 17 |
| 10 | 40 | 47 | 41 |
| 20 | 40 | 68 | 62 |

### Test Example 2

### Test for Examining Controlling Effect of Compound 1-2 and Fluxapyroxad on Wheat Fusarium Head Blight

A synergetic effect, which was showed on wheat Fusarium head blight in a case where a mixture of the compound 1-2 and fluxapyroxad was sprayed, was examined in the same manner as Test Example 1 except that the compound 1-2 was used instead of using the compound I-1.

Table 2 shows the result of the test. As is clear from Table 2, an actual preventive value, which was obtained in a case where the mixture of the compound 1-2 and fluxapyroxad was actually sprayed, is larger than a theoretical preventive value that was calculated on the basis of (i) a preventive value obtained in a case where the compound 1-2 is sprayed and (ii) a preventive value obtained in a case where fluxspyroxad is sprayed. The compound 1-2 and fluxapyroxad showed the synergistic effect.

TABLE 2

| | | | Theoretical preventive value |
|---|---|---|---|
| | | Actual | in case where mixture of |
| Compound | Fluxapyroxad | preventive | Compound I-2 and |
| I-2 (g/ha) | (g/ha) | value | Fluxapyroxad is sprayed |
| 0 | 0 | 0 | |
| 5 | 0 | 34 | |
| 10 | 0 | 45 | |
| 15 | 0 | 62 | |
| 20 | 0 | 78 | |
| 0 | 10 | 8 | |
| 5 | 10 | 47 | 40 |
| 10 | 10 | 56 | 49 |
| 15 | 10 | 69 | 65 |
| 0 | 20 | 16 | |
| 5 | 20 | 49 | 45 |
| 10 | 20 | 71 | 54 |
| 15 | 20 | 87 | 69 |
| 20 | 20 | 91 | 81 |
| 0 | 30 | 14 | |
| 5 | 30 | 55 | 43 |
| 10 | 30 | 67 | 53 |
| 15 | 30 | 78 | 68 |
| 20 | 30 | 82 | 81 |
| 0 | 40 | 9 | |
| 10 | 40 | 65 | 50 |
| 15 | 40 | 82 | 66 |
| 20 | 40 | 91 | 80 |

### Test Example 3

### Test for Examining Controlling Effect of Compound I-1 and Fluxapyroxad on Wheat Brown Rust

Wheat (cultivar: Monopol) was seeded in a field, and wheat plants in ear emergence were obtained. Examined was an effect of controlling wheat brown rust of the wheat plants, which effect was showed by a sprayed chemical. Chemical suspensions each of which contained the compound I-1 and fluxapyroxad, and chemical suspensions containing respective comparative chemicals were diluted with water so that each ingredient of the chemical suspensions was in a predetermined amount to be used. Then, 400 L/ha of each of the chemical suspensions was sprayed over the wheat plants. The comparative chemicals were Adexar (product name; manufactured by BASF), Opus (product name; manufactured by BASF), Proline (product name; manufactured by Bayer Crop Science), and Caramba (product name; manufactured by BASF). In 28 days after the spray, whether or not wheat brown rust occurred was examined.

Table 3 shows the result of the test. As is clear from Table 3, the chemical suspensions each of which contained the compound I-1 and fluxapyroxad showed a greater effect of controlling wheat brown rust than the chemical suspensions containing the respective commercially-available comparative chemicals.

TABLE 3

| | Amount to be | Disease occurrence area ratio in |
|---|---|---|
| Chemicals | sprayed (g/ha) | 28 days after spray (%) |
| Compound I-1 | 125 | 1 |
| Fluxapyroxad | 125 | |
| Compound I-1 | 90 | 2 |
| Fluxapyroxad | 125 | |
| Compound I-1 | 63 | 2 |
| Fluxapyroxad | 125 | |
| Adexar | 250 | 3 |
| Opus | 125 | 9 |
| Proline | 200 | 27 |
| Caramba | 90 | 10 |
| none | — | 31 |

### Test Example 4

### Test for Examining Controlling Effect of Compound I-1 and Fluxapyroxad on Wheat Leaf Blight

Wheat (cultivar: Riband) was seeded in a field, and wheat plants on internode elongation stage were obtained. Examined was an effect of controlling wheat leaf blight of the wheat plants, which effect was showed by a sprayed chemical. Chemical suspensions each of which contained the compound I-1 and fluxapyroxad, and chemical suspensions containing respective comparative chemicals were diluted with water so that each ingredient of the chemical suspensions was in a predetermined amount to be used. Then, 400 L/ha of each of the chemical suspensions was sprayed over the wheat plants. The comparative chemicals were Adexar (product name; manufactured by BASF), Opus (product name; manufactured by BASF), Proline (product name; manufactured by Bayer Crop Science); and Caramba (product name; manufactured by BASF). In 29 days after the spray, whether or not wheat leaf blight occurred was examined.

Table 4 shows the result of the test. As is clear from Table 4, the chemical suspensions each of which contained the compound I-1 and fluxapyroxad showed a greater effect of controlling wheat leaf blight than the chemical suspensions containing the respective commercially-available comparative chemicals.

TABLE 4

| | Amount to be | Disease occurrence area ratio in |
|---|---|---|
| Chemicals | sprayed (g/ha) | 29 days after spray (%) |
| Compound I-1 | 125 | 1 |
| Fluxapyroxad | 125 | |
| Compound I-1 | 90 | 1 |
| Fluxapyroxad | 125 | |
| Compound I-1 | 63 | 2 |
| Fluxapyroxad | 125 | |
| Adexar | 250 | 3 |
| Opus | 125 | 13 |
| Proline | 200 | 6 |
| Caramba | 90 | 15 |
| none | — | 38 |

### Test Example 5

### Test for Examining Controlling Effect of Compound I-1 and Fluxapyroxad on Wheat Brown Rust

Wheat seeds (cultivar: NORIN No. 61) were sown in a field in autumn of one (1) year earlier than a year when chemicals were sprayed, and the chemicals were sprayed over wheat plants at the flowering stage of the wheat plants. Examined was an effect of controlling brown rust of wheat, which effect was showed by the sprayed chemicals. Specifically, the wheat seeds were sown in two rows with 30 cm inter-row spacing in the field in the autumn. (i) Chemical suspensions each of which contained the compound I-1 and Fluxapyroxad, (ii) a chemical suspension containing the compound I-1 and (iii) chemical suspensions each of which contained Fluxapyroxad, were diluted with water so that each ingredient of the chemical suspensions was in a predetermined amount to be used. Each of the chemical suspensions was then sprayed over the wheat plants at the flowering stage in the year. After the spray of the chemical suspensions, a pot, in which diseased wheat plants with brown rust were planted, was put in each test plot between the two rows of the wheat plants so that the wheat plants were prompted to get infected with wheat brown rust. Each test was conducted in three test plots, each of which test plots is of 0.5 m×4 m (2 m²). In 20 days after the spray of the chemical suspensions, the occurrence of wheat brown rust was investigated in 20 flag leaves which were selected at random from one of the three test plots. An index of the occurrence (index of disease severity of wheat brown rust) was then calculated. A theoretical preventive value (an expected preventive value) obtained in a case where the chemical suspension containing the compound I-1 and Fluxapyroxad is sprayed was calculated, by use of the above Colby's formula (see Test Example 1), on the basis of (i) a preventive value obtained in a case where only the compound I-1 is sprayed and (ii) a preventive value obtained in a case where only fluxapyroxad is sprayed. In a case where an actual preventive value obtained in a case where the chemical suspension containing the compound I-1 and Fluxapyroxad was actually sprayed is larger than the theoretical preventive value, it was determined that the chemical suspension containing the compound I-1 and Fluxapyroxad showed a synergistic effect. In a case where the actual preventive value was equal to the theoretical preventive value, it was determined that the chemical suspension containing the compound I-1 and Fluxapyroxad showed an additional effect. In a case where the actual preventive value was smaller than the theoretical preventive value, it was determined that the chemical suspension containing the compound I-1 and Fluxapyroxad showed an antagonistic effect.

Table 5 shows the result obtained by calculating actual preventive values on the basis of respective average disease occurrence area ratios of the flag leaves. Table 6 shows the result obtained by calculating actual preventive values on the basis of respective disease occurrence ratios of the flag leaves. As is clear from Tables 5 and 6, the actual preventive values are larger than respective theoretical preventive values. The compound I-1 and fluxapyroxad showed a synergistic effect.

TABLE 5

| | | | Theoretical preventive value |
|---|---|---|---|
| | | Actual | in case where mixture of |
| Compound | Fluxapyroxad | preventive | Compound I-1 and |
| I-1 (g/ha) | (g/ha) | value | Fluxapyroxad is sprayed |
| 0 | 0 | 0 | |
| 7.5 | 0 | 42.6 | |
| 0 | 7.5 | 29.3 | |
| 0 | 30 | 80.6 | |
| 7.5 | 7.5 | 84.9 | 59.4 |
| 7.5 | 30 | 94.4 | 88.9 |

TABLE 6

| | | | Theoretical preventive value |
|---|---|---|---|
| | | Actual | in case where mixture of |
| Compound | Fluxapyroxad | preventive | Compound I-1 and |
| I-1 (g/ha) | (g/ha) | value | Fluxapyroxad is sprayed |
| 0 | 0 | 0 | |
| 7.5 | 0 | 16.4 | |
| 0 | 7.5 | 6.8 | |
| 0 | 30 | 64.4 | |
| 7.5 | 7.5 | 65.7 | 22.0 |
| 7.5 | 30 | 80.8 | 70.2 |

### INDUSTRIAL APPLICABILITY

The present invention can be used as a plant disease controlling agent, which causes less harmful effects on plants in controlling plant diseases.

1. A plant disease controlling agent, comprising, as active ingredients, (i) fluxapyroxad and (ii) a triazole compound which is represented by general formula (I), 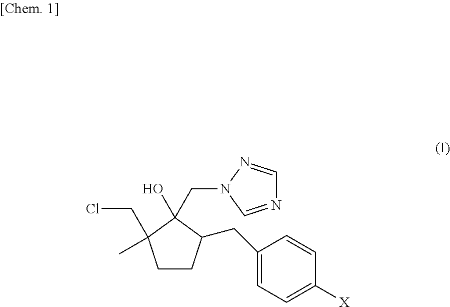
where X represents a chlorine atom or a fluorine atom.

2. The plant disease controlling agent as set forth in claim 1, wherein a mixture ratio by weight of the triazole compound to the fluxapyroxad falls within a range from 20:1 to 1:80.

3. The plant disease controlling agent as set forth in claim 1, wherein a mixture ratio by weight of the triazole compound to the fluxapyroxad falls within a range from 2:1 to 1:8.

4. The plant disease controlling agent as set forth in claim 1, being for use in controlling wheat diseases.

5. A plant disease controlling method, comprising the step of carrying out a foliage treatment or a non-foliage treatment by use of a plant disease controlling agent as set forth in claim 1.

6. A plant disease controlling product, separately comprising fluxapyroxad, and a triazole compound which is represented by general formula (I), 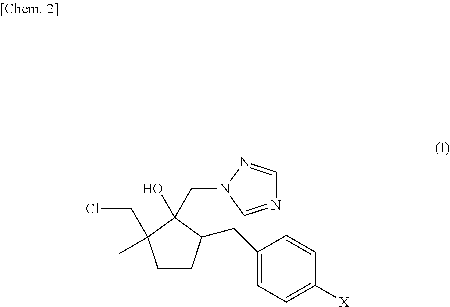
where X represents a chlorine atom or a fluorine atom,
the fluxapyroxad and the triazole compound being active ingredients to be mixed with each other before use.
